(19) United States
(12) Patent Application Publication
(10) Pub. No.: US 2024/0317449 A1
(43) Pub. Date: Sep. 26, 2024

(54) CERAMIC BALL STORAGE TRAY AND METHOD OF STORING CERAMIC BALLS USING THE SAME

(71) Applicants: KABUSHIKI KAISHA TOSHIBA, Toyko (JP); TOSHIBA MATERIALS CO., LTD., Yokohama-shi (JP)

(72) Inventors: Katsuhiko YAMADA, Yokohama Kanagawa (JP); Ryo SAKAI, Yokohama Kanagawa (JP); Shoya SANO, Yokohama Kanagawa (JP); Haruhiko YAMAGUTI, Yokohama Kanagawa (JP); Akihiro YAMADA, Yokohama Kanagawa (JP); Akira SATO, Yokohama Kanagawa (JP)

(73) Assignees: KABUSHIKI KAISHA TOSHIBA, Toyko (JP); TOSHIBA MATERIALS CO., LTD., Yokohama-shi (JP)

(21) Appl. No.: 18/668,367

(22) Filed: May 20, 2024

Related U.S. Application Data
(63) Continuation of application No. PCT/JP2022/042901, filed on Nov. 18, 2022.

(30) Foreign Application Priority Data
Nov. 22, 2021 (JP) 2021-189250

(51) Int. Cl. B65D 1/36; B65B 5/08; B65D 85/58

(52) U.S. Cl. CPC B65D 1/36; B65B 5/08; B65D 85/58

(57) ABSTRACT

A ceramic ball storage tray includes a storage portion that stores a ceramic ball. The storage portion of the ceramic ball storage tray has a protruding portion formed such that a center of a bottom surface portion of the storage portion is hollow. A height of an outer circumferential surface of the protruding portion relative to a diameter of the ceramic ball is within a range of 0.05 or more and 0.30 or less. A height of the storage portion relative to the diameter of the ceramic ball is preferably within a range of 1.05 or more and 2.00 or less. A height of an inner circumferential surface of the protruding portion relative to the diameter of the ceramic ball is preferably within a range of 0.01 or more and 0.10 or less.

### CROSS-REFERENCE TO RELATED APPLICATION

This application is a Continuation Application of No. PCT/JP2022/042901, filed on Nov. 18, 2022, and the PCT application is based upon and claims the benefit of priority from Japanese Patent Application No. 2021-189250, filed on Nov. 22, 2021, the entire contents of which are incorporated herein by reference.

### FIELD

Embodiments described later relate to a ceramic ball storage tray and a method of storing ceramic balls using the same.

### BACKGROUND

Ceramic balls are used in fields such as bearings. Various materials are used for ceramics, such as silicon nitride, aluminum oxide, and zirconium oxide. For example, Japanese Patent No. 5487099 (Patent Document 1) discloses a bearing ball made of a silicon nitride sintered body. The ceramic ball of Patent Document 1 has excellent wear resistance even if it is large with a diameter of about 20 mm.

Bearings each have a structure in which a plurality of bearing balls are installed between an outer ring and an inner ring. In other words, a plurality of bearing balls are required to manufacture one bearing. As a result, it has been necessary to transport a plurality of ceramic balls.

For example, Japanese Patent Laid-Open No. 2004-18050 (Patent Document 2) discloses a container made of paper for storing bearing balls. Patent Document 2 discloses a container using thick paper in which at least two or more sheets of cardboard liner are laminated. The container made of paper of Patent Document 2 shows that even if a plurality of bearing balls are stored, the container will not be damaged.

When a plurality of bearing balls are transported in the container of Patent Document 2, the plurality of bearing balls are stored together in the container. When a plurality of bearing balls are stored in one container, problems arise in that the balls come into contact with each other in transportation, causing cracks and chips in the balls. In addition, bearing balls made of ceramics are polished to be spherical. Before polishing, each ceramic ball has a band-shaped portion. For example, Japanese Patent No. 4761613 (Patent Document 3) discloses a ceramic ball having a band-shaped portion. Placing a plurality of ceramic balls each having a band-shaped portion in one container causes many cracks and chips in the balls. This is because the band-shaped portions are easily damaged if they collide with each other.

A problem to be solved by a ceramic ball storage tray and a method of storing ceramic balls using the same according to embodiments is to reduce damage of ceramic balls stored in the ceramic ball storage tray in order to address such problems.

### BRIEF DESCRIPTION OF THE DRAWINGS

FIG. 1 is a top view showing an example of a ceramic ball storage tray according to an embodiment.

FIG. 2A is a side view showing the example of the ceramic ball storage tray according to the embodiment.

FIG. 2B is a IIB-IIB cross-sectional view showing the example of the ceramic ball storage tray according to the embodiment.

FIG. 2C is a IIC-IIC cross-sectional view showing the example of the ceramic ball storage tray according to the embodiment.

FIG. 3 is an enlarged view showing the III-III cross section of a storage portion of the ceramic ball storage tray according to the embodiment.

FIG. 4 is an enlarged view showing the IV-IV cross section of the storage portion in a state in which the ceramic ball storage trays according to the embodiment are stacked in an up-down direction.

### DETAILED DESCRIPTION

Hereinafter, embodiments of a ceramic ball storage tray and a method of storing ceramic balls using the same will be described in detail with reference to the drawings.

The ceramic ball storage trays according to the embodiments each have storage portions that store ceramic balls. The storage portions of the ceramic ball storage tray each have a protruding portion formed such that a center of the bottom surface portion of the storage portion is hollow. In addition, a height of the outer circumferential surface of the protruding portion relative to the diameter of the ceramic ball is within a range of 0.05 or more and 0.30 or less.

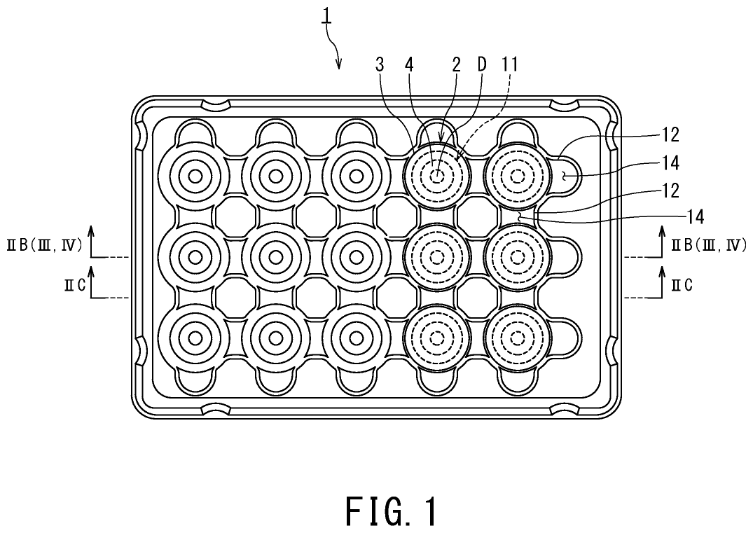

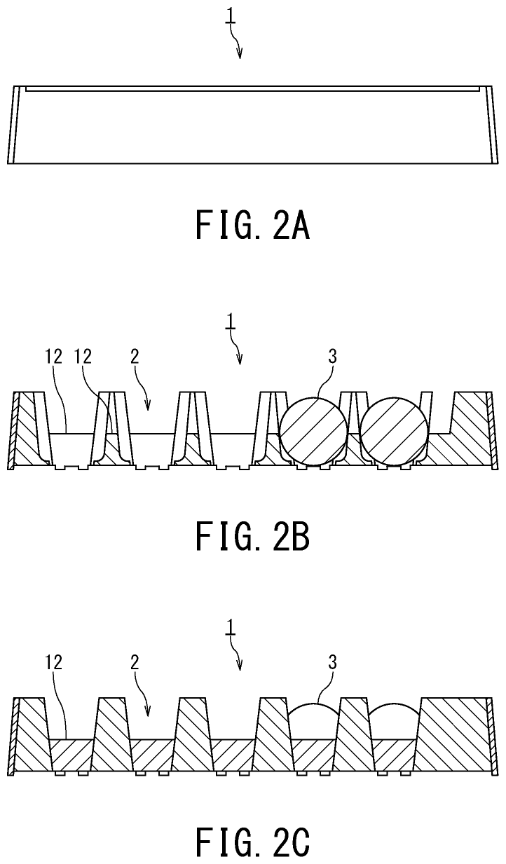

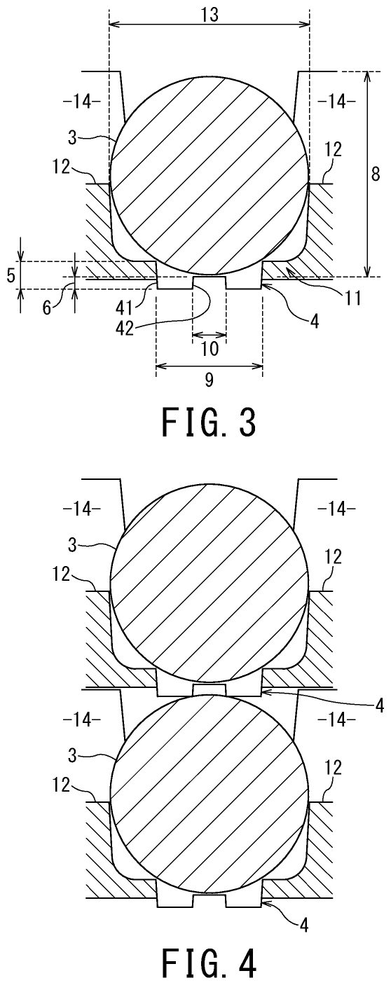

FIG. 1 is a top view showing an example of a ceramic ball storage tray according to an embodiment. FIG. 2A is a side view showing the example of the ceramic ball storage tray according to the embodiment. FIG. 2B is a IIB-IIB cross-sectional view showing the example of the ceramic ball storage tray according to the embodiment. FIG. 2C is a IIC-IIC cross sectional view showing the example of the ceramic ball storage tray according to the embodiment. FIG. 3 is an enlarged view showing the III-III cross section of a storage portion of the ceramic ball storage tray according to the embodiment. FIG. 4 is an enlarged view showing the IV-IV cross section of the storage portions in a state in which the ceramic ball storage trays according to the embodiment are stacked in the up-down direction.

In the figures, a reference numeral 1 denotes a ceramic ball storage tray, a reference numeral 2 denotes a storage portion, a reference numeral 3 denotes a ceramic ball, a reference numeral 4 denotes a protruding portion, a reference numeral 5 denotes a height of an outer circumferential surface of the protruding portion 4, a reference numeral 6 denotes a height of an inner circumferential surface of the protruding portion 4, a reference numeral 7 denotes a diameter of the ceramic ball 3, a reference numeral 8 denotes a height of the storage portion 2, a reference numeral 9 denotes a diameter of an outer circumferential surface of the protruding portion 4, a reference numeral 10 denotes a diameter of an inner circumferential surface of the protruding portion 4, a reference numeral 11 denotes a bottom surface portion, a reference numeral 12 denotes a circumferential portion of the storage portion 2, a reference numeral 13 denotes a diameter of the storage portion 2, and a reference numeral 14 denotes a recess in the circumferential portion 12. FIG. 1 illustrates the ceramic ball storage tray 1 comprising 15 storage portions 2. The tray 1 is not limited to this, and the number of storage portions 2 can be increased or decreased. Furthermore, FIG. 1 illustrates the ceramic ball storage tray 1 having three storage portions arranged in the longitudinal direction and five storage portions arranged in the transverse direction, but the numbers can also be increased or decreased as appropriate. The ceramic ball storage tray 1 may also be referred to as a storage tray 1 or a tray 1. In addition, the ceramic ball 3 may be simply referred to as a ball 3. Note that FIG. 1 shows a state in which two rows of the storage portions 2 on the right side store the ceramic balls 3 therein.

The storage tray 1 has storage portions 2. The storage portions 2 can each store a ceramic ball 3. Each storage portion 2 has a protruding portion 4 formed such that the center of the bottom surface portion 11 is hollow. The bottom surface portion 11 of the storage portion 2 is designed to prevent the ceramic ball 3 from falling out. An opposite side (that is, a ceiling side) of the bottom surface portion 11 is an opening portion so that the ceramic ball 3 can be easily stored.

Each protruding portion 4 of the bottom surface portion 11 of the storage portion 2 has a shape that protrudes downward from the bottom surface portion 11. Presence of the protruding portions 4 makes it possible to absorb the impact when the tray 1 is transported (that is, when the ceramic balls 3 are transported). Furthermore, as will be described later, presence of protruding portions 4 in the storage portions 2 can prevent direct contact between the ceramic balls 3 that are adjacent to each other in the up-down direction when the storage trays 1 are stacked in the up-down direction. In addition, it is preferable that each protruding portion 4 should have a hollow cylindrical shape formed such that the center of the bottom surface portion 11 is hollow. Since the protruding portion 4 is a hollow cylinder, the strength of the protruding portion 4 can be improved. Hereinafter, a case will be described in which the protruding portion 4 is a hollow cylinder having a circular shape when viewed from above, but the protruding portion 4 is not limited to this case. For example, there may be a case in which the protruding portion 4 may have a polygonal shape when viewed from above.

Also, the diameter 7 of each ceramic ball 3 is called a ball diameter 7. The ceramic ball 3 may be a ceramic ball with a band-shaped portion. Manufacturing a ceramic ball using metal molding creates a ceramic ball with a band-shaped portion. Polishing the ceramic ball with the band-shaped portion creates a true spherical ceramic ball. The storage tray 1 may store any of true spherical ceramic balls or ceramic balls with a band-shaped portion. In other words, shapes of the ceramic balls 3 include both a true spherical shape and a shape with a band-shaped portion. A ceramic ball before polishing is sometimes called a bare ball.

In addition, the ball diameter 7 is the maximum diameter of the ceramic ball 3. If the ceramic ball 3 is truly spherical, the maximum diameter is a freely-selected diameter. If the ceramic ball 3 has a band-shaped portion, the diagonal line of the band-shaped portion has the maximum diameter.

### (Height of an Outer Circumferential Surface and Height of an Inner Circumferential Surface of the Protruding Portion)

Since each protruding portion 4 has a hollow protruding shape, the protruding portion 4 has an outer circumferential surface 41 and an inner circumferential surface 42 that stand in the height direction. The height of the outer circumferential surface 41 is denoted by 5, and the height of the inner circumferential surface 42 is denoted by 6. The height 5 of the outer circumferential surface 41 of the protruding portion 4 is sometimes referred to as an outer circumferential height 5. The height 6 of the inner circumferential surface 42 of the protruding portion 4 is sometimes referred to as an inner circumferential height 6. In order to hold the stored ceramic balls 3 on the ceiling side of the inner circumferential surface 42, the height 6 of the inner circumferential surface 42 is desirably lower than the height 5 of the outer circumferential surface 41.

For example, it is preferable that “outer circumferential height 5 of the protruding portion/ball diameter 7”, which is the height 6 of the outer circumferential surface 41 of the protruding portion 4 relative to the ball diameter 7, should be within a range of 0.05 or more and 0.30 or less. The “outer circumferential height 5/ball diameter 7” within the range of 0.05 or more and 0.30 or less can prevent direct contact between the ceramic balls 3 adjacent in the up-down direction when a plurality of storage trays 1 are stacked in the up-down direction. Furthermore, damage to the ceramic balls 3 due to vibrations in transportation of the tray 1 can be prevented.

If the “outer circumferential height 5/ball diameter 7” is less than 0.05, an effect of providing the protruding portion 4 cannot be obtained. In addition, if the “outer circumferential height 5/ball diameter 7” exceeds 0.30, the protruding portion 4 is too high. If each protruding portion 4 is high, the stability when the trays 1 are stacked in the up-down direction may decrease. Therefore, the “outer circumferential height 5/ball diameter 7” is preferably within the range of 0.05 or more and 0.30 or less, more preferably 0.10 or more and 0.25 or less.

In addition, it is preferable that “inner circumferential height 6 of the protruding portion/ball diameter 7”, which is the height 6 of the inner circumferential surface 42 of the protruding portion 4 relative to the diameter 7 of the ceramic ball 3, should be within a range of 0.01 or more and 0.10 or less. It is desirable that the height 6 of the inner circumferential surface 42 is lower than the height 5 of the outer circumferential surface 41. The inner circumferential height 6 of the protruding portion 4 is the height of the inner circumferential side of the hollow protruding portion 4. The “inner circumferential height 6 of the protruding portion/ball diameter 7” within the range of 0.01 or more and 0.10 or less allows the inner circumferential side of the protruding portion 4 to press down the ceramic balls 3 stored in the lower tray 1 when a plurality of trays 1 are stacked in the up-down direction. Even if a plurality of trays 1 are stacked and transported, movement of the stored ceramic balls 3 can be prevented. This can prevent damage to the ceramic balls 3 in transportation of the tray 1.

If the “inner circumferential height 6 of protruding portion/ball diameter 7” is less than 0.01, the inner circumferential height 6 of the protruding portion 4 is small. This causes the bottom surface portion 11 of the storage portion 2 of the upper tray 1 to be highly likely to come into direct contact with the ceramic ball 3 of the lower tray 1 when a plurality of trays 1 are stacked in the up-down direction. As the area increases in which each bottom surface of the tray 1 is in direct contact with the ceramic ball 3, a stress applied to the ceramic balls 3 increases, increasing damage possibility. In addition, if the “inner circumferential height 6/ball diameter 7” exceeds 0.10, the height of the protruding portion 4 may be too high.

### (The Height of the Storage Portion 2)

Furthermore, it is preferable that “height of the storage portion 8/ball diameter 7”, which is the height of the storage portion 2 relative to the diameter 7 of the ceramic ball 3, should be within a range of 1.05 or more and 2.00 or less. The height 8 of the storage portion 2 is a length from the bottom surface portion 11 of the storage portion 2 to the opening portion on the opposite side.

First, draw a vertical line in the up-down direction from the center of the bottom surface portion 11 of the storage portion 2. Next, draw a horizontal line (perpendicular to the vertical line) so as to connect the opening portion of the storage portion 2 from end to end. The length from the center of the bottom surface portion 11 of the storage portion 2 to the intersection of the vertical line and the horizontal line is defined as the height 8 of the storage portion 2.

The “height 8 of storage portion/ball diameter 7” within the range of 1.05 or more and 2.00 or less can prevent the ceramic balls 3 from moving too much when the tray 1 is transported. Therefore, the ceramic balls 3 can be prevented from being damaged in transportation of the tray 1. Furthermore, even the ceramic ball 3 with a band-shaped portion can be prevented from damage.

The “height 8 of storage portion/ball diameter 7” less than 1.05 may cause each protruding portion 4 of the upper tray 1 to apply more stress than necessary to the ceramic ball 3 stored in the lower tray 1 when a plurality of trays 1 are stacked in the up-down direction. Contrarily, the “height of storage portion 8/ball diameter 7” exceeding 2.00 may decrease the effect of preventing excessive movement of the ceramic ball 3 in transportation even when a plurality of trays 1 are stacked in the up-down direction. Therefore, it is preferable that a ratio of the “height of storage portion 8/ball diameter 7” be within the range of 1.05 or more and 2.00 or less, more preferably 1.08 or more and 1.60 or less.

### (The Diameter of the Storage Portion 2)

It is preferable that “diameter 13 of storage portion/diameter 7 of ball”, which is the diameter 13 of the storage portion 2 relative to the diameter 7 of the ceramic ball 3, should be within the range of 1.05 or more and 1.70 or less. The “diameter 13 of storage portion/diameter 7 of ball” less than 1.05 may cause the ball 3 to have difficulty in entering in storage. Contrarily, the “diameter of storage portion/diameter of ball” exceeding 1.70 may cause the ball 3 to move too much in transportation of the tray 1.

FIG. 4 shows an example of stacking the storage trays 1. The structure is such that, when a plurality of storage trays 1 are stacked in the up-down direction, each protruding portion 4 of the upper tray 1 presses down the ball stored in the lower tray 1. This can prevent movement of the balls 3 in transportation of the trays 1.

It is also preferable that the outer circumferential height 5 of the protruding portion 4 be larger than the inner circumferential height 6 of the protruding portion 4. The fact that the outer circumferential height 5 of the protruding portion 4 is larger than the inner circumferential height 6 of the protruding portion 4 indicates that there is a step in the bottom surface portion 11 of the storage portion 2. Thereby, one ceramic ball 3 can be supported at a plurality of locations. As a result, movement of the ceramic ball 3 in transportation of the tray 1 can be prevented. Moreover, it is preferable that the outer circumferential height 5 of the protruding portion 4 be 3 mm or more. Setting the outer circumferential height 5 of the protruding portion 4 to 3 mm or more makes it easy to form the step on the bottom surface portion 11 of the storage portion 2. Furthermore, when a plurality of trays 1 are stacked in the up-down direction, the protruding portions 4 play a role in preventing misalignment. In addition, the inner circumferential surface of the storage portion 2 can take various shapes such as a spherical shape and a stepped shape. For example, the inner circumferential surface of the storage portion 2 may be made into a spherical shape, and the protruding portion 4 may be made into a cavity. The portion made into a cavity forms a step. Furthermore, the protruding portions 4 each made into a cavity makes it possible to improve the cushioning properties for the ceramic balls 3 when a plurality of trays 1 are stacked in the up-down direction. Moreover, weight of the tray 1 can also be reduced.

### (The Diameter of the Outer Circumferential Surface 41 and the Diameter of the Inner Circumferential Surface 42)

It is preferable that “outer circumferential diameter 9 of the protruding portion/ball diameter 7”, which is the diameter 9 of the outer circumferential surface 41 of the protruding portion 4 relative to the diameter 7 of the ceramic ball 3, should be within a range of 0.3 or more and 0.8 or less. In addition, it is preferable that “inner circumferential diameter of the protruding portion 10/ball diameter 7”, which is the diameter 10 of the inner circumferential surface 42 of the protruding portion 4 relative to the diameter 7 of the ceramic ball 3, should be within a range of 0.1 or more and 0.6 or less. It goes without saying that the inner circumferential diameter 10 is smaller than the outer circumferential diameter 9. The outer circumferential diameter 9 of the protruding portion 4 is the outer diameter at the head end portion (that is, the lower end portion) of the protruding portion 4. In addition, the inner circumferential diameter 10 of the protruding portion 4 is the inner diameter at the head end portion (that is, the lower end portion) of the protruding portion.

The “outer circumferential diameter 9 of the protruding portion/diameter 7 of the ball” within the range of 0.3 or more and 0.8 or less can provide an effect of causing the protruding portion 4 to press down the ceramic ball 3 stored in the lower tray 1 when a plurality of trays 1 are stacked in the up-down direction. Likewise, the “inner circumferential diameter 10/ball diameter 7” within the range of 0.1 or more and 0.6 or less can provide an effect of causing the protruding portion 4 to press down the ceramic ball 3 stored in the lower tray 1 when a plurality of trays 1 are stacked in the up-down direction.

If the “outer circumferential diameter 9 of the protruding portion/ball diameter 7” is less than 0.3, the outer diameter 9 of the protruding portion 4 may be too small. If the outer circumferential diameter 9 of the protruding portion 4 is small, a difference between the outer circumferential diameter 9 and the inner circumferential diameter 10 may be small. If the difference between the outer circumferential diameter 9 and the inner circumferential diameter 10 is small, the area of the protruding portion 4 in contact with the ceramic ball 3 stored in the lower tray 1 is small when a plurality of trays 1 are stacked in the up-down direction. Vibration in transportation of the tray 1 causes the protruding portion 4 to be in sharp contact with the ceramic ball 3, which may cause damage.

Contrarily, if the “outer circumferential diameter 9 of the protruding portion/ball diameter 7” exceeds 0.8, the outer diameter of the protruding portion 4 may be too large. Even if the outer diameter of the protruding portion 4 is increased, no further effect can be obtained. Furthermore, if the ratio of “outer circumferential diameter 9 of the protruding portion/ball diameter 7” is 0.8 or less, there is an effect of reducing the weight of the storage tray 1.

On the other hand, the “inner circumferential diameter of the protruding portion 10/ball diameter 7” within the range of 0.1 or more and 0.6 or less can further provide an effect of pressing down the ceramic ball 3 stored in the lower tray 1 when a plurality of trays 1 are stacked in the up-down direction.

In contrast, if the “inner circumferential diameter 10 of the protruding portion/ball diameter 7” is less than 0.1, the inner circumferential diameter 10 may be too small. Contrarily, if the “inner circumferential diameter of the protruding portion 10/ball diameter 7” exceeds 0.6, a width of the protruding portion 4 may be too narrow. The too narrow width of the protruding portion 4 causes the protruding portion 4 to be in sharp contact with the ceramic ball 3 stored in the lower tray 1 when a plurality of trays 1 are stacked in the up-down direction, which may cause damage.

For this reason, it is preferable to satisfy both of the following: the “outer circumferential diameter of the protrusion 9/ball diameter 7” is 0.3 or more and 0.8 or less; and the “inner circumferential diameter 10 of the protruding portion/ball diameter 7” is 0.1 or more and 0.6 or less.

### (The Circumferential Portion 12)

There are the circumferential portions 12 around the storage portions 2. Each circumferential portion 12 connects adjacent storage portions 2. The circumferential portion 12 may be a casing that covers side surfaces of the storage portion 2. In addition, the circumferential portions 12 may be provided further outside of the storage portions 2 at the end (for example, the upper end, lower end, and right end in FIG. 1) out of the plurality of storage portions 2. It is preferable to provide a recess 14 in each circumferential portion 12 around the storage portion 2 from the opening portion side of the tray 1 toward the bottom surface portion 11 side thereof. This can make it easier to insert fingers or a robot arm holding the ball 3 through the recess 14 from the opening portion of the tray 1 toward the storage portion 2 thereof, allowing the ball 3 to be set in the storage portion 2 more easily. Furthermore, this can make it easier to grip the ball 3 stored in the storage portion 2 with fingers or a robot arm through the recess 14, allowing the ball 3 stored in the storage portion 2 to be taken out from the tray 1 more easily.

### (Materials for the Storage Tray 1)

Preferably, the storage tray 1 is made of plastic. Plastic is also called synthetic resin. Plastic is a plastic substance, the main raw material of which is a polymer material derived from petroleum or the like. Plastic can be formed by applying heat and pressure. Since plastic can be formed, it is suitable for forming the storage portions 2 as aforementioned. The materials for the tray 1 include plastic, rubber, paper, glass, and ceramics. Of these, plastic is suitable from the viewpoint of strength and weight reduction. The plastics include polyethylene terephthalate (PET), polypropylene (PP), and polyethylene (PE). Of these, polyethylene terephthalate is preferred. This is because polyethylene terephthalate has good recyclability.

### (The Ceramic Ball 3)

It is preferable that the diameter 7 of each ceramic ball 3 stored in the storage tray 1 be 10 mm or more. In other words, each storage portion 2 has a size and shape that can store the ceramic ball 3 having a diameter of 10 mm or more. Increase in the diameter of each ceramic ball 3 also increases the area in which the ceramic ball 3 comes into contact with another ceramic ball 3 due to vibration in transportation of the storage tray 1. Furthermore, increase in the diameter of the ceramic ball 3 also increases the weight of the ceramic ball 3. Increase in the weight also increases the stress caused by collision due to vibration. Use of the storage trays 1 according to the embodiments can reduce the influence of vibration in transportation. In other words, it can be said that the storage tray 1 is a tray effective for storing ceramic balls 3 each having a diameter of 10 mm or more. Note that the upper limit of the diameter of the ceramic ball 3 is not particularly limited, but is preferably 100 mm or less. In addition, the storage trays 1 according to the embodiments may also be applied to ceramic balls 3 each having a diameter of less than 10 mm.

In addition, the ceramic balls 3 include one or two or more sintered bodies selected from silicon nitride sintered bodies, sialon sintered bodies, aluminum oxide sintered bodies, zirconium oxide sintered bodies, and argil sintered bodies. Argil sintered bodies are each a sintered body of a mixture of aluminum oxide and zirconium oxide. For example, the silicon nitride sintered bodies include a sintered body containing 85% by mass or more of silicon nitride.

It is preferable that the ceramic balls 3 be silicon nitride sintered bodies. Silicon nitride sintered bodies are more expensive than aluminum oxide sintered bodies or the like. If the ceramic balls 3 are damaged in transportation of the tray 1, there will be a large economic loss. For this reason, the storage trays 1 of the embodiments are preferably applied to ceramic balls 3 made of silicon nitride sintered bodies.

Additionally, silicon nitride sintered bodies, sialon sintered bodies, zirconium oxide sintered bodies, and argil sintered bodies include ones each having a three-point bending strength of 800 MPa or more. In contrast, the aluminum oxide sintered bodies each have a three-point bending strength of about 300 to 500 MPa. Even if the ceramic balls 3 stored in the storage trays 1 of the embodiments are aluminum oxide ceramic balls with low strength, damage can be prevented.

### (A Method of Storing the Ceramic Balls 3)

A method of storing the ceramic balls 3 uses the storage tray 1 as described above, and stores the ceramic balls 3 in a storage process. Specifically, the storage process includes: a step of inserting fingers or a robot arm holding the ceramic ball 3 from the opening portion of the storage tray 1 toward the storage portion 2, and setting the ball 3 in the storage portion 2 for storage; and a step of stacking a plurality of storage trays 1, in which ceramic balls 3 are stored, in the up-down direction. The method of storing the ceramic balls 3 includes subsequently transporting a plurality of storage trays 1 stacked in the up-down direction in a step of transportation. The configuration of the storage trays 1 can prevent damage to the ceramic balls 3 due to vibrations in transportation of the storage trays 1.

Note that, when the storage tray 1 is provided with a plurality of storage portions 2, the storage tray 1 may store the ceramic balls 3 in a part of the storage portions 2. For example, polishing a ceramic ball 3 with a band-shaped portion creates a true spherical ceramic ball 3. The true spherical ceramic ball 3 can be used as a bearing ball. Furthermore, a bearing is assembled using a plurality of bearing balls. In completion of bearings, a step of transporting the trays 1 is involved. It is important to prevent damage to the ceramic balls 3 in transportation of the trays 1.

### (Ways of a Vibration Test and a Drop Test)

In the storage trays 1 according to the embodiments, a plurality of storage trays 1 storing balls 3 may be stacked in the up-down direction. The storage portions 2 with the above configuration can prevent adjacent ceramic balls 3 in the up-down direction from coming into contact with each other when a plurality of storage trays 1 are stacked in the up-down direction. Furthermore, when a plurality of storage trays 1 are stacked in the up-down direction, the ceramic balls 3 adjacent in the up-down direction may be in contact with each other via the protruding portions 4. If a plurality of storage trays 1 can be stacked, the trays 1 can be transported efficiently. Furthermore, providing the protruding portion 4 as aforementioned makes it possible to have a structure in which the upper and lower trays 1 are fitted together. This can prevent the upper and lower trays 1 from being misaligned when a plurality of trays 1 are stacked and transported.

The storage trays 1 as described above can prevent the ceramic balls 3 from being damaged due to vibration or drop. The performance of the storage trays 1 can be evaluated using the vibration test and drop test specified in JIS-Z-0200 (2013). Note that JIS-Z-0200 corresponds to ISO4180.

Even if JIS-Z-0200 vibration test level 1 and drop test level 1 are performed, damage to the ceramic balls 3 can be prevented. The vibration tests include different levels, and the level 1 has the most severe conditions. Likewise, drop tests includes different levels, and the level 1 has the most severe conditions.

The storage trays 1 according to the embodiments are not damaged even if they are each subjected to the vibration test level 1 and the drop test level 1. Furthermore, even if the trays 1 storing the ceramic balls 3 are subjected to the vibration test level 1, the damage to the ceramic balls 3 can be 0% or more and 1% or less. Likewise, even if the trays 1 storing the ceramic balls 3 are subjected to the drop test level 1, the damage to the ceramic balls 3 can be 0% or more and 1% or less. Therefore, the ceramic balls 3 can be prevented from damage in transportation.

### EXAMPLES

### Examples 1 to 10, and Comparative Examples 1 to 4

The storage trays 1 according to Examples 1 to 10 and the storage trays according to Comparative Examples 1 to 4 were prepared each of which was made of plastic and had a width of 523 mm and a length of 415 mm. The storage trays 1 according to Examples 1 to 10 were each provided with storage portions 2. In contrast, the storage trays according to Comparative Examples 1 and 4 were not provided with the storage portion 2, and the storage trays according to Comparative Examples 2 and 3 were each provided with storage portions outside the range of the storage portion 2. The shapes of the ceramic balls to be stored and the storage portions were shown in Table 1.

The ceramic balls stored in the storage trays in Examples 1 to 8 and Comparative Examples 1 to 3 were each made of a silicon nitride sintered body. The ceramic balls stored in the storage trays according to Examples 9 to 10 and Comparative Example 4 were each made of an aluminum oxide sintered body. The ceramic balls made of the silicon nitride sintered bodies are used each of which had a three-point bending strength of 950 MPa. The ceramic balls made of the aluminum oxide were used each of which had a three-point bending strength of 400 MPa.

TABLE 1

| | Ceramic Ball | | | |
|---|---|---|---|---|
| | | Presence | | |
| | | or Absence | Storage Portion | |
| | | of Band- | Height mm | Diameter mm |
| | Diameter | Shaped | of Storage | of Storage |
| | mm | Portion | Portion | Portion |
| Example 1 | 24 | Presence | 36 | 34 |
| Example 2 | 33 | Absence | 36 | 35 |
| Example 3 | 35 | Presence | 49 | 43 |
| Example 4 | 43 | Absence | 49 | 44 |
| Example 5 | 44 | Presence | 55 | 49 |
| Example 6 | 49 | Absence | 55 | 50 |
| Example 7 | 50 | Presence | 66 | 59 |
| Example 8 | 59 | Absence | 66 | 59 |
| Example 9 | 24 | Presence | 36 | 34 |
| Example 10 | 33 | Absence | 36 | 35 |
| Comparative | 24 | Presence | Absence | — |
| Example 1 | | | | |
| Comparative | 24 | Presence | 36 | 34 |
| Example 2 | | | | |
| Comparative | 24 | Presence | 36 | 34 |
| Example 3 | | | | |
| Comparative | 24 | Presence | Absence | — |
| Example 4 | | | | |

| | Storage Portion | | | |
|---|---|---|---|---|
| | Protruding Portion | | | |
| | Outer | Inner | Outer | Inner |
| | Circum- | Circum- | Circum- | Circum- |
| | ferential | ferential | ferential | ferential |
| | Height mm | Height | Diameter mm | Diameter mm |
| Example 1 | 4 | 1 | 16 | 8 |
| Example 2 | 5 | 1 | 16 | 10 |
| Example 3 | 7 | 1 | 22 | 10 |
| Example 4 | 7 | 2 | 20 | 10 |
| Example 5 | 8 | 2 | 24 | 8 |
| Example 6 | 9 | 2 | 26 | 10 |
| Example 7 | 9 | 3 | 30 | 10 |
| Example 8 | 10 | 3 | 32 | 12 |
| Example 9 | 3 | 1 | 16 | 8 |
| Example 10 | 5 | 1 | 16 | 10 |
| Comparative | — | — | — | — |
| Example 1 | | | | |
| Comparative | Absence | Absence | Absence | Absence |
| Example 2 | | | | |
| Comparative | 12 | 5 | 16 | 8 |
| Example 3 | | | | |
| Comparative | — | — | — | — |
| Example 4 | | | | |

Comparative Example 1 and Comparative Example 4 were made into rectangular containers each having a width of 523 mm and a length of 415 mm. For this reason, the containers of Comparative Example 1 were not provided with a storage portion.

Comparative Example 2 was the same as Example 1 except that no protruding portion was provided. In Comparative Example 3, the outer circumferential height/ball diameter was 0.5.

Regarding each of the storage trays according to the examples and comparative examples, Table 2 shows the outer circumferential height of the protruding portion/ball diameter, the inner circumferential height of the protruding portion/ball diameter, the outer circumferential diameter of the protruding portion/ball diameter, the inner circumferential diameter of the protruding portion/ball diameter, the height of the storage portion/ball diameter, and the number of storage portions in one storage tray.

TABLE 2

| | Outer | Inner | Outer |
|---|---|---|---|
| | Circumferential | Circumferential | Circumferential |
| | Height of | Height of | Diameter of |
| | Protruding | Protruding | Protruding |
| | Portion/ | Portion/ | Portion/ |
| | Ball Diameter | Ball Diameter | Ball Diameter |
| Example 1 | 0.17 | 0.04 | 0.67 |
| Example 2 | 0.15 | 0.03 | 0.48 |
| Example 3 | 0.20 | 0.03 | 0.63 |
| Example 4 | 0.16 | 0.05 | 0.47 |
| Example 5 | 0.18 | 0.05 | 0.54 |
| Example 6 | 0.18 | 0.04 | 0.53 |
| Example 7 | 0.18 | 0.06 | 0.60 |
| Example 8 | 0.17 | 0.05 | 0.54 |
| Example 9 | 0.13 | 0.04 | 0.67 |
| Example 10 | 0.15 | 0.03 | 0.48 |
| Comparative | — | — | — |
| Example 1 | | | |
| Comparative | 0 | 0 | 0 |
| Example 2 | | | |
| Comparative | 0.50 | 0.21 | 0.67 |
| Example 3 | | | |
| Comparative | — | — | — |
| Example 4 | | | |
| | Inner | | |
| | Circumferential | | |
| | Diameter of | Height of | |
| | Protruding | Storage | The Number of |
| | Portion/ | Portion/ | Storage |
| | Ball Diameter | Ball Diameter | Portions |
| Example 1 | 0.33 | 1.50 | 15 |
| Example 2 | 0.30 | 1.09 | 20 |
| Example 3 | 0.29 | 1.41 | 30 |
| Example 4 | 0.23 | 1.15 | 15 |
| Example 5 | 0.18 | 1.24 | 15 |
| Example 6 | 0.20 | 1.11 | 15 |
| Example 7 | 0.20 | 1.32 | 12 |
| Example 8 | 0.20 | 1.12 | 10 |
| Example 9 | 0.33 | 1.5 | 15 |
| Example 10 | 0.30 | 1.09 | 20 |
| Comparative | — | — | 1 |
| Example 1 | | | |
| Comparative | 0 | 1.50 | 15 |
| Example 2 | | | |
| Comparative | 0.33 | 1.50 | 15 |
| Example 3 | | | |
| Comparative | — | — | 1 |
| Example 4 | | | |

Ceramic balls were stored in all the storage portions of the storage trays according to the examples and comparative examples. In Comparative Examples 1 and 4, 20 ceramic balls were stored in one storage portion.

The vibration test and the drop test were conducted for each storage tray according to the examples and comparative examples. Each test was conducted for three storage trays, each storing ceramic balls, stacked in the up-down direction. Each set of the three stacked storage trays packed in cardboard and secured with cable ties was used as a sample. The cable ties secured the sample at two locations in the longitudinal direction and at two locations in the transverse direction.

Each vibration test was conducted in accordance with JIS-Z-0200 (2013) random vibration test level 1. The vibration frequency was 6 Hz, the vibration direction was vertical direction, and the vibration test was carried out for 180 minutes.

Each drop test was conducted in accordance with JIS-Z-0200 (2013) level 1. The height for drop was 60 cm. The dropping order was 2-3-5 corner, 3-5 edge, 2-3 edge, 2-5 edge, 2-3-6 corner, 3-6 edge, 2-6 edge, face 5, face 6, face 2, face 3, and face 1.

The ceramic balls were examined for damage after each of the vibration tests and the drop tests. The tests were each conducted with prepared ten samples.

The percentage of ceramic balls that were damaged in each of the vibration tests and drop tests was investigated as a damage rate (%). The damage rate (%) is calculated from the following formula.

$$Damage rate ( \% ) = ( number of damaged balls / number of balls stored in the storage portion ) \times 100$$

The results are shown in Table 3.

TABLE 3

| | Damage Rate % | Damage Rate % |
|---|---|---|
| | in Vibration Test | In Drop Test |
| Example 1 | 0 | 0 |
| Example 2 | 0 | 0 |
| Example 3 | 0 | 0 |
| Example 4 | 0 | 0 |
| Example 5 | 0 | 0 |
| Example 6 | 0 | 0 |
| Example 7 | 0 | 0 |
| Example 8 | 0 | 0 |
| Example 9 | 0 | 0 |
| Example 10 | 0 | 0 |
| Comparative | 18 | 27 |
| Example 1 | | |
| Comparative | 5 | 8 |
| Example 2 | | |
| Comparative | 9 | 11 |
| Example 3 | | |
| Comparative | 29 | 35 |
| Example 4 | | |

As can be seen from Table 3, when the storage trays 1 according to Examples 1 to 10 were used, no damage to the ceramic balls was confirmed. Even the ceramic balls of aluminum oxide sintered bodies with low strength, like the storage trays 1 of Examples 9 and 10, had no damage.

The square boxes with no storage portion as in Comparative Examples 1 and 4 each had high damage rates. In particular, the ceramic balls made of the aluminum oxide sintered bodies with low strength shown in Comparative Example 4 had remarkably high damage rates. Furthermore, the samples in which each storage portion had no protruding portion, as in Comparative Example 2, did not fully press down the balls with the protruding portions when the trays were stacked in the up-down direction, resulting in high damage rates. Contrarily, the samples having the too high protruding portions, as in Comparative Example 3, each had a large stress on the balls stored in the lower trays when the trays were stacked in the up-down direction, resulting in high damage rates.

According to at least one embodiment described above, it is possible to reduce damage such as cracks and chips of the ceramic balls stored in the ceramic ball storage trays.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A ceramic ball storage tray comprising a storage portion that stores a ceramic ball, wherein
the storage portion has a protruding portion formed such that a center of a bottom surface portion of the storage portion is hollow, and
a height of an outer circumferential surface of the protruding portion relative to a diameter of the ceramic ball is within a range of 0.05 or more and 0.30 or less.

2. The ceramic ball storage tray according to claim 1, wherein a height of the storage portion relative to the diameter of the ceramic ball is within a range of 1.05 or more and 2.00 or less.

3. The ceramic ball storage tray according to claim 1, wherein a height of an inner circumferential surface of the protruding portion relative to the diameter of the ceramic ball is within a range of 0.01 or more and 0.10 or less.

4. The ceramic ball storage tray according to claim 1, wherein a diameter of the outer circumferential surface of the protruding portion relative to the diameter of the ceramic ball is within a range of 0.3 or more and 0.8 or less.

5. The ceramic ball storage tray according to claim 1, wherein a diameter of an inner circumferential surface of the protruding portion relative to the diameter of the ceramic ball is within a range of 0.1 or more and 0.6 or less.

6. The ceramic ball storage tray according to claim 1, wherein the storage portion has a size and shape that stores the ceramic ball having a diameter of 10 mm or more.

7. The ceramic ball storage tray according to claim 1, wherein a height of the outer circumferential surface of the protruding portion is 3 mm or more.

8. The ceramic ball storage tray according to claim 1, wherein the ceramic ball storage tray is made of plastic.

9. The ceramic ball storage tray according to claim 1, wherein the protruding portion has a hollow cylindrical shape formed such that the center of the bottom surface portion is hollow.

10. The ceramic ball storage tray according to claim 2, wherein a height of an inner circumferential surface of the protruding portion relative to the diameter of the ceramic ball is within a range of 0.01 or more and 0.10 or less.

11. The ceramic ball storage tray according to claim 10, wherein a diameter of the outer circumferential surface of the protruding portion relative to the diameter of the ceramic ball is within a range of 0.3 or more and 0.8 or less.

12. The ceramic ball storage tray according to claim 11, wherein a diameter of an inner circumferential surface of the protruding portion relative to the diameter of the ceramic ball is within a range of 0.1 or more and 0.6 or less.

13. The ceramic ball storage tray according to claim 12, wherein the protruding portion has a hollow cylindrical shape formed such that the center of the bottom surface portion is hollow.

14. A method of storing ceramic balls, comprising:
using a plurality of ceramic ball storage trays according to claim 1; and
stacking the plurality of ceramic ball storage trays in an up-down direction, the ceramic ball storage trays each storing the ceramic ball.

15. The method of storing ceramic balls according to claim 14, wherein, when the plurality of ceramic ball storage trays are stacked in the up-down direction, ceramic balls adjacent in the up-down direction do not come into contact with each other.

16. The method of storing ceramic balls according to claim 14, wherein, when the plurality of ceramic ball storage trays are stacked in the up-down direction, ceramic balls adjacent in the up-down direction are in contact with each other via the protruding portion.

17. The method of storing ceramic balls according to claim 14, further comprising:
storing the ceramic ball with a band-shaped portion at each of the plurality of ceramic ball storage trays; and
stacking the plurality of ceramic ball storage trays in the up-down direction.

18. The method of storing ceramic balls according to claim 14, further comprising:
storing the ceramic ball made of a silicon nitride sintered body at each of the plurality of ceramic ball storage trays; and
stacking the plurality of ceramic ball storage trays in the up-down direction.

19. The method of storing ceramic balls according to claim 14, further comprising transporting the plurality of ceramic ball storage trays at each of which the ceramic ball is stored in a state in which the ceramic ball storage trays are stacked in the up-down direction.

20. A method of storing ceramic balls, comprising:
using a plurality of ceramic ball storage trays according to claim 13; and
stacking the plurality of ceramic ball storage trays in an up-down direction, the ceramic ball storage trays each storing the ceramic ball.
